(19) United States
(12) Patent Application Publication
(10) Pub. No.: US 2026/0128938 A1
(43) Pub. Date: May 7, 2026

(54) CONSTELLATIONS FOR WIRELESS COMMUNICATION

(71) Applicant: Lenovo (United States) Inc., Morrisville, NC (US)

(72) Inventors: Junghoon Kim, Chicago, IL (US); Venkata Srinivas Kothapalli, Aurora, IL (US)

(73) Assignee: Lenovo (United States) Inc., Morrisville, NC (US)

(21) Appl. No.: 19/183,311

(22) Filed: Apr. 18, 2025

(51) Int. Cl. H04L 27/34

(52) U.S. Cl. CPC H04L 27/3405

(57) ABSTRACT

Various aspects of the present disclosure relate to constellations for wireless communication. An apparatus (e.g., network equipment (NE), user equipment (UE)) generates a set of constellations associated with wireless communication, wherein the set of constellations includes a plurality of pairs of constellations, wherein each pair of constellations includes a first constellation for transmission of the wireless communication and a second constellation for reception of the wireless communication. The apparatus transmits information of at least a subset of the set of constellations.

### TECHNICAL FIELD

The present disclosure relates to wireless communications, and more specifically to modulation and coding in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The devices (e.g., NE, UE), processors, and methods of the present disclosure each have several innovative aspects, no single one of which is solely responsible for the desirable features disclosed herein.

An apparatus (e.g., a NE, UE) for wireless communication is described. The apparatus may be configured to, capable of, or operable to perform one or more operations as described herein. For example, the apparatus may be configured to, capable of, or operable to generate a set of constellations associated with wireless communication, wherein the set of constellations includes a plurality of pairs of constellations, wherein each pair of constellations includes a first constellation for transmission of the wireless communication and a second constellation for reception of the wireless communication; and transmit information of at least a subset of the set of constellations.

A processor (e.g., a standalone processor chipset, or a component of an apparatus (e.g., UE, NE)) for wireless communication is described. The processor may be configured to, capable of, or operable to perform one or more operations as described herein. For example, the processor may be configured to, capable of, or operable to generate a set of constellations associated with wireless communication, wherein the set of constellations includes a plurality of pairs of constellations, wherein each pair of constellations includes a first constellation for transmission of the wireless communication and a second constellation for reception of the wireless communication; and transmit information of at least a subset of the set of constellations.

A method performed or performable by an apparatus (e.g., UE, NE) for wireless communication is described. The method may include generating a set of constellations associated with wireless communication, wherein the set of constellations includes a plurality of pairs of constellations, wherein each pair of constellations includes a first constellation for transmission of the wireless communication and a second constellation for reception of the wireless communication; and transmitting information of at least a subset of the set of constellations.

In some implementations of the apparatus, the processor, and the method described herein, the first constellation is configured for bit mapping, and wherein the second constellation is configured for bit demapping; the first constellation and the second constellation have different constellation arrangements; the set of constellations is generated based at least in part on an objective function; the objective function is based at least in part on a bit-interleaved coded modulation (BICM) function; the objective function is based at least in part on a first constellation for a transmitter constellation and a second constellation for a receiver constellation, and wherein the first constellation is associated with generating a symbol for transmission, and the second constellation is associated with calculating a likelihood ratio associated with the symbol for transmission; the objective function is associated with one or more constraints, and wherein the one or more constraints are based at least in part on power normalization for the set of constellations; the set of constellations includes non-uniform constellations.

In some implementations of the apparatus, the processor, and the method described herein, the set of constellations includes one or more of a one-dimensional non-uniform constellation, a two-dimensional non-uniform constellation, or a M-ary amplitude phase shift keying (M-APSK) constellation; the one or more constraints are based at least in part on one or more constellation types for the set of constellations; the constellation information is generated based at least in part on an objective function, and wherein the objective function is determined based at least in part on one or more of an exhaustive search, a particle swarm optimization, a genetic algorithm, or a Nelder-Mead algorithm; the first constellation is generated based at least in part on an objective function, and the second constellation is determined based at least in part on a predefined constellation for reception of wireless communication; the predefined constellation includes a quadrature amplitude modulation (QAM) constellation; the information of at least a subset of the set of constellations is transmitted to a second apparatus for transmission or reception of wireless communication.

An apparatus (e.g., a NE, UE) for wireless communication is described. The apparatus may be configured to, capable of, or operable to perform one or more operations as described herein. For example, the apparatus may be configured to, capable of, or operable to receive information of at least a subset of a set of constellations, wherein the subset includes a pair of constellations including a first constellation for transmission of the wireless communication and a second constellation for reception of the wireless communication; and receive or transmit data based at least in part on the subset of the set of constellations.

A processor (e.g., a standalone processor chipset, or a component of an apparatus (e.g., UE, NE)) for wireless communication is described. The processor may be configured to, capable of, or operable to perform one or more operations as described herein. For example, the processor may be configured to, capable of, or operable to receive information of at least a subset of a set of constellations, wherein the subset includes a pair of constellations including a first constellation for transmission of the wireless communication and a second constellation for reception of the wireless communication; and receive or transmit data based at least in part on the subset of the set of constellations.

A method performed or performable by an apparatus (e.g., UE, NE) for wireless communication is described. The method may include receiving information of at least a subset of a set of constellations, wherein the subset includes a pair of constellations including a first constellation for transmission of the wireless communication and a second constellation for reception of the wireless communication; and receiving or transmitting data based at least in part on the subset of the set of constellations.

In some implementations of the apparatus, the processor, and the method described herein, the first constellation and the second constellation include different constellation arrangements; the first constellation and the second constellation include non-uniform constellations.

### BRIEF DESCRIPTION OF THE DRAWINGS

FIG. 1 illustrates an example of a wireless communications system in accordance with aspects of the present disclosure.

FIG. 2 illustrates an example system in accordance with aspects of the present disclosure.

FIGS. 3 and 4 illustrate different constellation arrangements for wireless communications systems.

FIG. 5 illustrates an example system in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method in accordance with aspects of the present disclosure.

FIG. 10 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. Channel coding and modulation schemes can be employed as part of using time-frequency resources in wireless communication, for example, to enable efficient data transmission and error correction using time-frequency resources. Some modulation and coding schemes use constellations (also known as constellations symbols), which involve mapping data symbols of data to be transmitted to specific points in a complex plane, known as constellation points. These constellation points represent different signal states that can be transmitted over a communication channel. In examples, each constellation point is a combination of phase and amplitude, with phase represented by the angle and amplitude by the distance from the center of a constellation diagram.

In some wireless communications systems, uniform QAM constellations can be used for mapping and demapping of encoded data. While QAM constellations may reduce computational complexity for mapping and demapping, QAM constellations may yield performance loss in terms of data rates and error probability. To address these shortcomings, non-uniform constellations (NUC) may be used, which may provide gains in data rates and error probability. However, NUC may involve greater complexity for mapping and demapping compared to QAM constellations. For example, demapping complexity can be significantly higher due to the non-uniform structure of NUC.

Aspects of the present disclosure are described in the context of a wireless communications system and include implementations that provide techniques to generate (e.g., jointly construct) constellations for transmitter and receiver entities. As discussed herein, the terms “transmitter constellation” and “receiver constellation” may refer to sets of signal points (e.g., constellations) used respectively by a transmitter entity (e.g., a UE and/or an NE) for mapping encoded data (e.g., encoded symbols) and by a receiver entity (e.g., a UE and/or an NE) for demapping encoded data. Implementations may utilize non-paired constellations, where a transmitter entity and receiver entity employ different respective constellations. In some examples, a transmitter constellation can be generated that aligns with a receiver constellation, and the transmitter constellation and the receiver constellation can be based on different respective constellation designs and/or constellation configurations. In some examples, a transmitter constellation that aligns with a receiver constellation can enable encoded and mapped data from a transmitter entity to be accurately demapped by a receiver entity using a receiver entity constellation.

By performing the described techniques, devices in a wireless communications system can realize improved encoding and decoding capabilities, while conserving computational and network resources. In examples, a receiver entity is not constrained to use the same constellation as a transmitter entity, allowing the receiver entity to choose a lower-complexity constellation based on its capabilities. In some examples, decoupling the constellation choice for mapping and demapping can enable backward compatibility in wireless communications systems. For example, a transmitter entity can utilize an advanced constellation (e.g., a non-uniform constellation), while a receiver entity can utilize a legacy (e.g., QAM) constellation. Such implementations can improve wireless performance while ensuring seamless integration with legacy systems, representing an improvement over existing NUC designs.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

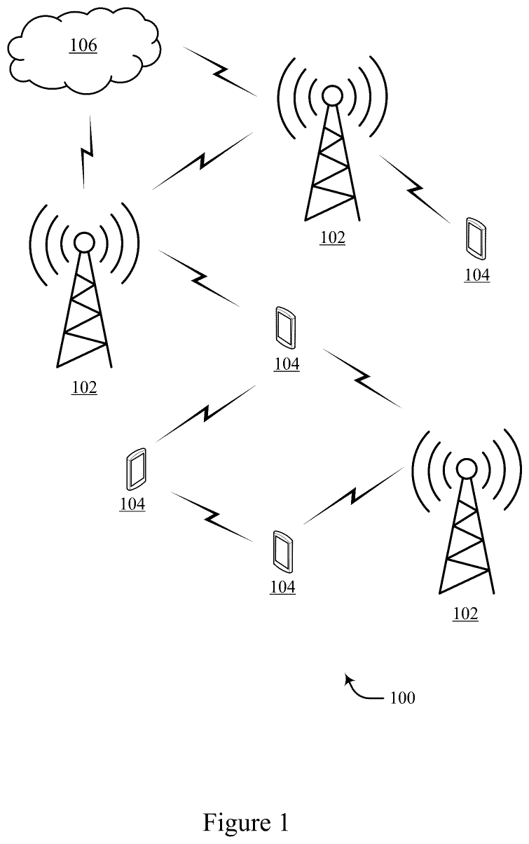

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHZ), FR4 (52.6 GHZ-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 KHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a first apparatus (e.g., a NE 102, a UE 104) generates a set of constellations associated with wireless communication, wherein the set of constellations includes a plurality of pairs of constellations, wherein each pair of constellations comprises a first constellation for transmission of the wireless communication and a second constellation for reception of the wireless communication. The first apparatus transmits information of at least a subset of the set of constellations to a second apparatus, e.g., a different NE 102, a different UE 104.

In another example, a second apparatus (e.g., a NE 102, a UE 104) receives information of at least a subset of a set of constellations, wherein the subset includes a pair of constellations including a first constellation for transmission of the wireless communication and a second constellation for reception of the wireless communication. The second apparatus receives or transmits data based at least in part on the information of the at least a subset of the set of constellations.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

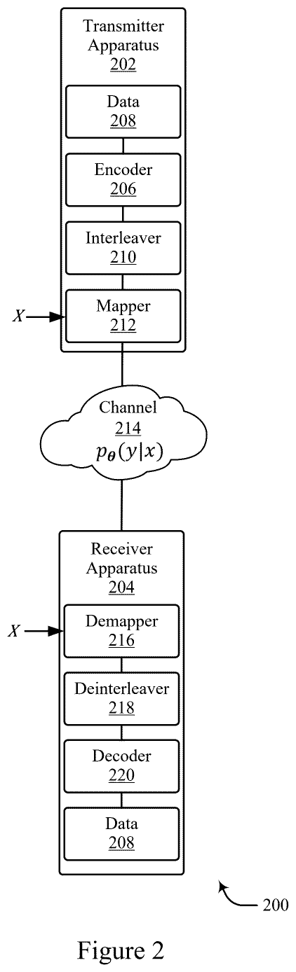

FIG. 2 illustrates an example system 200 in accordance with aspects of the present disclosure. The system 200 can be implemented for BICM. The system 200 includes a transmitter apparatus 202 and a receiver apparatus 204. In the system 200, an encoder 206 at the transmitter apparatus 202 applies forward error correction (FEC) coding to encode data 208 (e.g., information bits). An interleaver 210 then applies interleaving to the encoded data, which may cause the encoded bits to be independent from each other. A mapper 212 applies mapping to the interleaved encoded information bits. For mapping by the mapper 212, each m encoded bits may be mapped to a corresponding transmit symbol based on a constellation X, where m represents a modulation order. The number of symbols in the constellation may be denoted by M=2^{m}. For example, if m=2, each two bits are mapped to one of the four symbols (M=4) in the constellation X. The sequence of mapped symbols may be transmitted by the transmitter apparatus 202 to the receiver apparatus 204 via a channel 214.

The receiver apparatus 204 receives the sequence of mapped symbols which are demapped by a demapper 216, deinterleaved by a deinterleaver 218, and decoded by a decoder 220 to generate the data 208. The channel 214 may introduce noise and distortions to the transmitted symbols. The channel 214 may be represented as p_{θ}(y|x), where θ denotes the channel parameters that define its characteristics. For example, in a zero-mean additive white Gaussian noise (AWGN) channel, the receive symbol follows a complex Gaussian distribution p_{θ}(y|x)˜CN(0, σ²), where θ=σ² represents the noise power. The receiver apparatus 204 may process the noisy sequence of receive symbols and attempt to recover the original data 208. At the demapper 216, the receiver apparatus 204 may calculate the log-likelihood ratios (LLRs) of the transmitted bits given the receive symbol y, using the known constellation X. In BICM systems, this step can allow per-bit processing, reducing receiver complexity. The deinterleaver 218 can be applied to reorder the LLRs back to their original sequence before decoding. The receiver apparatus 204 can aggregate the LLRs from the receive symbols and feed them into the decoder 220 (e.g., FEC decoder) to reconstruct the original data 208, e.g., information bits. In the system 200, utilizing the interleaver 210 between the encoder 206 and the mapper 212 can enable the encoded bits to be independent after interleaving. This independence can enable the demapping process to be decoupled from the decoding process, which can reduce the receiver's complexity.

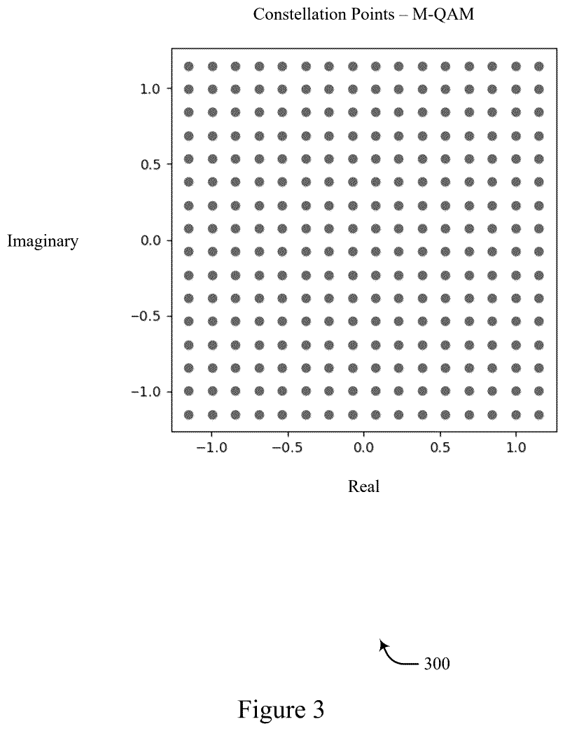

FIGS. 3 and 4 illustrate different constellation arrangements for wireless communications systems. FIG. 3 illustrates a QAM constellation 300 where symbols are approximately uniformly distributed on a rectangular grid, and FIG. 4 illustrates a non-uniform constellation 400 where symbols are arranged for AWGN channels by adjusting symbol placements considering BICM capacity.

In some wireless communications systems, uniform QAM constellations may be utilized. In such systems, the selection of a constellation X which defines a set of transmit symbols can impact signal shaping. In an AWGN channel, a transmit signal for achieving channel capacity may follow a Gaussian distribution. However, some systems cannot implement Gaussian signaling because it may involve an infinite number of symbols, which is infeasible. To address this issue, wireless communication standards (e.g., 3GPP) may utilize QAM constellations. QAM may simplify the demapping process at the receiver, and symbols in a QAM constellation may be uniformly spaced to generate a uniform constellation. The QAM constellation 300 illustrates an example of a QAM constellation where M=256.

A NUC represents a constellation where symbols are non-uniformly spaced. Unlike QAM, NUC is designed to optimize the shape of transmit signal. For instance, in an AWGN channel, NUC may better approximate Gaussian signaling by placing more symbols near the origin and fewer symbols further away, as illustrated in the constellation 400. While NUC may enable increased performance over QAM, its adoption in standardized wireless systems faces challenges. One challenge involves increased receiver complexity. Unlike QAM, NUC may involve the receiver using a non-uniform constellation for demapping, which can increase computational load. As a result, the complexity of NUC-based demapping may outweigh its benefits, particularly in some wireless communications systems where mobile devices as receivers may have limited processing power and computing resources. Thus, while NUC may provide advantages in improved performance, its practical feasibility remains an issue in its adoption for future wireless systems.

In some wireless communications systems (e.g., utilizing 3GPP standards), QAM constellations may be employed for both mapping and demapping. The QAM constellation 300, for example, represents a constellation where QAM constellation for M=256. A constellation X may include M complex-domain symbols, where adjacent symbols are equally spaced along a rectangular grid, where the x-axis denotes the in-phase/real component, while the y-axis represents the quadrature/imaginary component of each symbol. This uniform spacing may simplify the receiver's demapping process, which may reduce computational complexity.

In BICM systems, symbols may be assumed to occur with equal probability. Under this assumption, NUC design may focus on optimizing the constellation X to improve the channel capacity for BICM systems, e.g., BICM capacity defined as:

$${C}_{B I C M} ( X ) = {\sum }_{ℓ = 1}^{m} I ( {c}_{ℓ} ; y ) = m - {\sum }_{ℓ = 1}^{m} {E}_{b ∈ \{ 0 , 1 \} , {p}_{θ}} [ {log}_{2} \frac{{Σ}_{{x}^{′} ∈ X} {p}_{θ} ( {y}_{ℓ , b} \vert {x}^{′} )}{{Σ}_{{x}^{′} ∈ {x}_{ℓ , b}} {p}_{θ} ( {y}_{ℓ , b} \vert {x}^{′} )} ] .$$

Here, E is the expectation operator (with E_{b∈{0,1},θ} implying expectation over b∈{0,1} and θ) and [symbol] represents the [symbol] -th bit contained in the transmit symbol x. As an example, consider 4-QAM (M=4), where each transmit symbol x contains two bits (m=log₂ M=2). For instance, if x carries bits 10, then c₁=1 (first bit) and c₂=0 (second bit). The set [symbol] is a subset of X in which the [symbol] -th bit cₗ is b∈{0,1}. Note that the two sets, [symbol] and [symbol] , are complementary, i.e., X= [symbol] ∪ [symbol] . The receive symbol [symbol] is a noisy version of [symbol] ∈ [symbol] going through the channel, e.g.:

$${y}_{ℓ , b} \sim {p}_{θ} ( y \vert {x}_{ℓ , b} ) where {x}_{ℓ , b} ∈ {X}_{ℓ , b} .$$

An objective of NUC design is to maximize the BICM capacity while ensuring that the constellation is power-normalized. An optimization problem can be formulated as:

$${maximize}_{X} {C}_{BICM} ( X ) subject to$$

$${E}_{x ∈ X} [ {‖ x ‖}^{2} ] = 1$$

NUC may be designed differently depending on the channel properties. The NUC optimized for AWGN channels is provided in the right figure in FIG. 2. Here, 1D-NUC is considered as an example. The symbol placement in NUC (e.g., the constellation 400) resembles Gaussian signaling rather than the uniform QAM constellation (e.g., the constellation 300).

The BICM capacity of NUC may be higher than that of conventional QAM constellation because NUC is specifically designed to maximize the BICM capacity. As a result, NUC may provide better communication performance in terms of both capacity and error probability. However, this improvement may result in increased computational complexity, particularly in the demapping process at the receiver. Demapping in NUC may involve more computations than in QAM due to its non-uniform structure, making it more demanding in terms of computations. In contrast, QAM constellations provide a simplified mapping and demapping process due to their uniform structure, but this simplicity may result in decreased performance, as QAM is not an optimized constellation for maximizing capacity. Ultimately, neither QAM nor NUC individually provide an ideal balance between performance and practicality, as NUC requires high demapping complexity, whereas QAM compromises on performance.

Aspects of the present disclosure include solutions to utilize QAM and NUC constellations in wireless communications systems. In some implementations, non-paired constellations may be utilized where a transmitter and a receiver use different constellations rather than a shared constellation. In some examples, transmitter and receiver constellations can be generated using a BICM framework. A transmitter constellation may be generated to approximate optimal transmit signaling (e.g., Gaussian signaling for AWGN channels), and the transmitter constellation can be generated in conjunction with a receiver constellation that may differ from the transmitter constellation. The receiver constellation can be generated based on computational resources of the receiver. Some implementations can generate the transmitter constellation, while the receiver may utilize a predefined constellation (e.g., QAM constellation) without requiring additional constellation configuration associated with the receiver. By adopting a QAM constellation for demapping, a receiver may maintain low computational complexity while benefiting from the enhanced transmitter constellation, achieving a balance between performance and practicality. For example, a transmitter constellation can be generated based at least in part on an objective function, while the receiver constellation may be determined based at least in part on a predefined receiver constellation, which may represent a special case of generating both transmitter and receiver constellations.

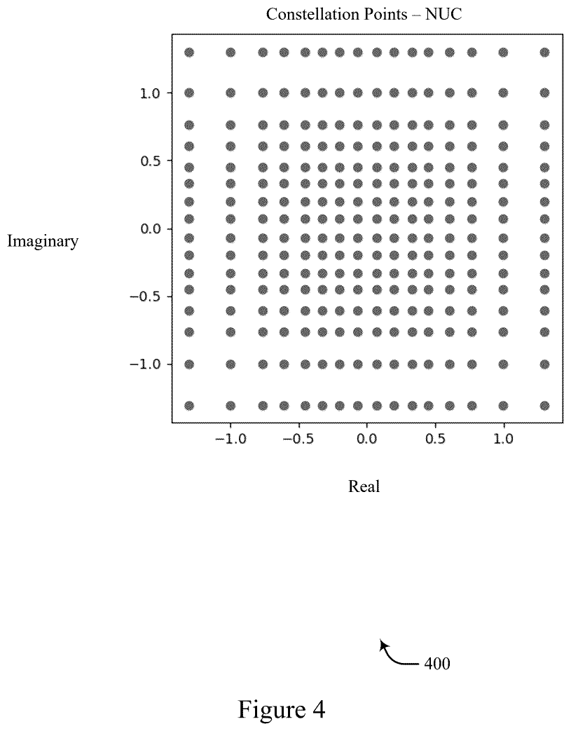

FIG. 5 illustrates an example system 500 in accordance with aspects of the present disclosure. The system 500 may represent a variation on the system 200 in accordance with aspects of the present disclosure. In the system 500, the transmitter apparatus 202 and the receiver apparatus 204 utilize non-paired constellations, e.g., different respective constellations for mapping by the mapper 212 and demapping by the demapper 216. The mapper 212 may utilize a constellation X^{Tx} and the demapper 216 may utilize a constellation X^{Rx}. To enable the system 500, techniques are described for generating the transmitter constellation X^{Tx} to align with the receiver constellation X^{Rx}.

In some implementations, the BICM capacity is analyzed in relation to the transmitter mapping and the receiver demapping processes using their respective constellations. The BICM capacity can be equivalently specified as:

$${C}_{BICM} ( X ) = m - {\sum }_{ℓ = 1}^{m} {E}_{b ∈ \{ 0 , 1 \} , {p}_{θ}} [ {log}_{2} ( 1 + \frac{{Σ}_{{x}^{′} ∈ {X}_{ℓ , \overline{b}}} {p}_{θ} ( {y}_{ℓ , b} \vert {x}^{′} )}{{Σ}_{{x}^{′} ∈ {X}_{ℓ , b}} {p}_{θ} ( {y}_{ℓ , b} \vert {x}^{′} )} ) ] where \qquad ( Equation 1 )$$

$${y}_{ℓ , b} \sim {p}_{θ} ( y \vert {x}_{ℓ , b} ) where {x}_{ℓ , b} ∈ {X}_{ℓ , b} . \qquad ( Equation 2 )$$

In Equation 1, b̅ is defined as a complementary value of b, such that b̅=1 when b=0, and b̅=0 when b=1. Using this definition, the subset [symbol] is complementary to the subset [symbol] meaning that the full constellation can be expressed as X= [symbol] ∪ [symbol] . In other words, these two subsets form a partition of X, ensuring that every symbol in the constellation belongs to one of these two groups. E is the expectation operator.

Given a constellation X, the BICM capacity C_{BICM}(X) can be computed from Equation 1 sing the following steps: Step 1. In Equation 2, a symbol [symbol] is randomly selected from the subset [symbol] of the constellation X. This symbol is then passed through the channel, producing a receive symbol [symbol] , as described in Equation 2. Step 2. In Equation 1, given the receive symbol [symbol] , we compute the likelihood probability p_{θ}( [symbol] |x′) for each x′ in both subsets [symbol] and [symbol] . The likelihoods are summed up to calculate the likelihood ratio as shown in Equation 2, and the remaining calculations from Equation 2 are then performed to finally obtain the BICM capacity C_{BICM}(X).

Regarding interpretation of Steps 1 and 2 in terms of transmitter and receiver operations, the constellation X may be used in both Steps 1 and 2. We observe that the use of a constellation in Step 1 is the mapping process at the transmitter, and in Step 2 the use of a constellation is the demapping process at the receiver. Step 1 may describe the transmitter's mapping process where symbols are chosen from a given constellation X. To further describe how Step 2 relates to the receiver operation, consider the receiver demapping process in BICM systems. In BICM systems, the receiver demapping process may include calculating the log-likelihood ratio (LLR) for each bit [symbol] , given by:

$${Λ}_{ℓ} = log \frac{p ( y \vert {c}_{ℓ} = 1 )}{p ( y \vert {c}_{ℓ} = 0 )} = log \frac{{Σ}_{{x}^{′} ∈ {X}_{ℓ , b = 1}} {p}_{θ} ( y \vert {x}^{′} )}{{Σ}_{{x}^{′} ∈ {X}_{ℓ , b = 0}} {p}_{θ} ( y \vert {x}^{′} )} . \qquad ( Equation 3 )$$

Equation 3 may match the calculation of the likelihood ratio in Equation 1 (Step 2). The BICM capacity may consider all bits c₁, . . . , cₘ collectively in a logarithmic sum, whereas LLR calculations in demapping may be based on individual bits [symbol] . This relationship highlights that optimizing BICM capacity inherently enhances the reliability of bit-level demapping/decoding at the receiver.

In some NUC designs, constellations may be optimized to maximize BICM capacity, assuming that the transmitter and receiver use the same constellation for mapping and demapping, respectively. However, such an assumption may limit flexibility, as the designed constellation does not perform well when the transmitter and receiver employ different constellations.

In some implementations, the transmitter constellation X^{Tx} and the receiver constellation X^{Rx} may be jointly designed and/or generated. In some examples, the BICM capacity formula is modified to define a new objective function. By modifying the BICM capacity formula in Equation 2 above, we define a new objective function as:

$$f ( {X}^{T x} , {X}^{R x} ) = m - {\sum }_{ℓ = 1}^{m} {E}_{b ∈ \{ 0 , 1 \} , {p}_{θ}} [ {log}_{2} ( 1 + \frac{{Σ}_{{x}^{′} ∈ {X}_{ℓ , \overline{b}}^{Rx}} {p}_{θ} ( {y}_{ℓ , b} \vert {x}^{′} )}{{Σ}_{{x}^{′} ∈ {X}_{ℓ , b}^{Rx}} {p}_{θ} ( {y}_{ℓ , b} \vert {x}^{′} )} ) ] , \qquad ( Equation 4 )$$

where the receive symbol [symbol] is a noisy version of transmit symbol [symbol] ∈

$${X}_{ℓ , b}^{Tx} ,$$

i.e.,

$${y}_{ℓ , b} \sim {p}_{θ} ( y \vert {x}_{ℓ , b} ) where {x}_{ℓ , b} ∈ {X}_{ℓ , b}^{Tx} . \qquad ( Equation 5 )$$

Some differences between the modified objective function in Equation 4 and the BICM capacity formula in Equation 1 include (i) the transmitter symbol selection (e.g., [symbol] ) may be randomly selected from a transmitter constellation

$${X}_{ℓ , b}^{Tx}$$

(as a subset of X^{Tx}), and (ii) the likelihood calculation, e.g., the likelihood is calculated based on a receiver's constellation X^{Rx}. Using the objective function in Equation 4, both the transmitter constellation X^{Tx} and the receiver constellation X^{Rx} can be generated by maximizing the objective function ƒ(X^{Tx}, X^{Rx}). This contrasts with some NUC designs, which may optimize only a single shared constellation used by both the transmitter and receiver.

In some implementations, wireless systems may design the transmitter constellation X^{Tx} while maintaining the receiver constellation X^{Rx} in a fixed state. The receiver may have a preferred constellation (e.g., QAM) to enable low-complexity demapping. In such cases, a constellation design variable may involve X^{Tx}, and the objective function may simplify to ƒ(X^{Tx}), where X^{Rx} remains fixed as the receiver constellation during optimization. The transmitter constellation X^{Tx} can be designed for a receiver using its own constellation X^{Rx}.

In some implementations, with the modified objective function, an optimization function can be formulated as:

$${maximize}_{{X}^{Tx} , {X}^{Rx}} f ( {X}^{Tx} , {X}^{Rx} ) subject to \qquad ( Equation 6 )$$

$${E}_{x ∈ {X}^{Tx}} [ {‖ x ‖}^{2} ] = 1 , {E}_{x ∈ {X}^{Rx}} [ {‖ x ‖}^{2} ] = 1.$$

The constraints in Equation 6 can enable both transmitter and receiver constellations to be power-normalized. One benefit of this approach is flexibility, allowing the transmitter and receiver to use different constellations for mapping and demapping, respectively, while the transmitter approximates its optimal signal shaping.

In wireless systems implemented to design the transmitter constellation X^{Tx} while maintaining the receiver constellation X^{Rx} in a fixed state, a design variable may be X^{Tx}. Consequently, an optimization function can be formulated as:

$${maximize}_{{X}^{Tx}} f ( {X}^{Tx} ) subject to \qquad ( Equation 7 )$$

$${E}_{x ∈ {X}^{Tx}} [ {‖ x ‖}^{2} ] = 1.$$

Equation 7 can enable the transmitter constellation to be optimized, while enabling the receiver to use a fixed constellation X^{Rx} (e.g., QAM constellation) for low-complexity demapping.

The described implementations can be applied to design any type of NUC, including but not limited to 1D-NUC, 2D-NUC, and M-APSK. Based on a selected constellation type, corresponding constraints can be added to the optimization problem. For example, in a 1D-NUC design, a constraint can be used to ensure that symbols are arranged in a rectangular shape and remain symmetric along both in the in-phase and quadrature axes. That is, the described implementations can be applicable to multiple NUC designs. Furthermore, different optimization methods to solve the optimization function, e.g., particle swarm optimization (PSO), Nelder-Mead algorithm, genetic algorithms (GA), etc. Since the described implementations are not limited to a specific optimization technique, the described implementations enable adaptability based on computational efficiency and convergence parameters.

Regarding communication with constellations generated as described herein, in joint constellation design scenarios, constellation pairs can be designed at a NE, which can be the transmitter, the receiver, or another device. Different constellation pairs can be designed based on various factors, including channel properties, transmitter/receiver constellation constraints, modulation orders, signal-to-noise ratios (SNRs), and/or coding rates. In some examples, before wireless communication is performed, an entity (e.g., NE, UE) that designs the constellation pairs may transmit the relevant constellation information to a corresponding entity. For example, if the transmitter designs the constellation pairs, the transmitter may transmit the receiver constellations to the receiver, and vice-versa. The associated signaling exchange may be a one-time transmission, after which the transmitter and receiver may communicate using one of the pairs of the designed constellations.

In scenarios that involve design of a transmitter constellation and not a receiver constellation, the transmitter may design its constellation, e.g., if the transmitter knows the receiver constellations in advance. For example, if the receiver selects to use a QAM constellation, the transmitter may design its own constellation to match a receiver using QAM and store the designed constellation. A diverse set of transmitter constellations can be designed based on various factors, such as channel properties, transmitter constellation constraints, modulation orders, SNRs, and coding rates. In such scenarios, no signaling exchange may be performed between the transmitter and receiver since the transmitter predesigns its constellation knowing the receiver constellation, and the receiver may independently use its own predefined constellation, e.g., a QAM constellation.

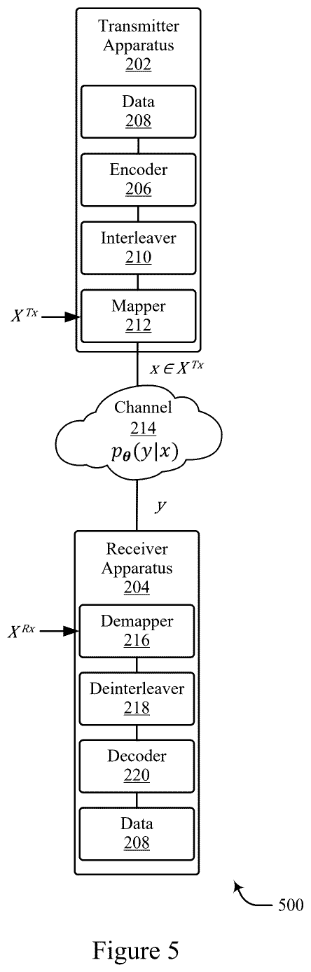

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

Additionally, or alternatively, the UE 600 may support at least one memory (e.g., the memory 604) and at least one processor (e.g., the processor 602) coupled with the at least one memory and configured to cause the UE to generate a set of constellations associated with wireless communication, wherein the set of constellations includes a plurality of pairs of constellations, wherein each pair of constellations includes a first constellation for transmission of the wireless communication and a second constellation for reception of the wireless communication; and transmit information of at least a subset of the set of constellations.

Additionally, the UE 600 may be configured to support any one or combination of where the first constellation is configured for bit mapping, and wherein the second constellation is configured for bit demapping; the first constellation and the second constellation have different constellation arrangements; the set of constellations is generated based at least in part on an objective function; the objective function is based at least in part on a BICM function; the objective function is based at least in part on a first constellation for a transmitter constellation and a second constellation for a receiver constellation, and wherein the first constellation is associated with generating a symbol for transmission, and the second constellation is associated with calculating a likelihood ratio associated with the symbol for transmission; the objective function is associated with one or more constraints, and wherein the one or more constraints are based at least in part on power normalization for the set of constellations; the set of constellations includes non-uniform constellations.

Additionally, the UE 600 may be configured to support any one or combination of where the set of constellations includes one or more of a one-dimensional non-uniform constellation, a two-dimensional non-uniform constellation, or a M-APSK constellation; the one or more constraints are based at least in part on one or more constellation types for the set of constellations; the constellation information is generated based at least in part on an objective function, and wherein the objective function is determined based at least in part on one or more of an exhaustive search, a particle swarm optimization, a genetic algorithm, or a Nelder-Mead algorithm; the first constellation is generated based at least in part on an objective function, and the second constellation is determined based at least in part on a predefined constellation for reception of wireless communication; the predefined constellation includes a QAM constellation; the information of at least a subset of the set of constellations is transmitted to a second apparatus for transmission or reception of wireless communication.

Additionally, or alternatively, the UE 600 may support at least one memory (e.g., the memory 604) and at least one processor (e.g., the processor 602) coupled with the at least one memory and configured to cause the UE to receive information of at least a subset of a set of constellations, wherein the subset includes a pair of constellations including a first constellation for transmission of the wireless communication and a second constellation for reception of the wireless communication; and receive or transmit data based at least in part on the subset of the set of constellations.

Additionally, the UE 600 may be configured to support any one or combination of where the first constellation and the second constellation include different constellation arrangements; the first constellation and the second constellation include non-uniform constellations.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or QAM. The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

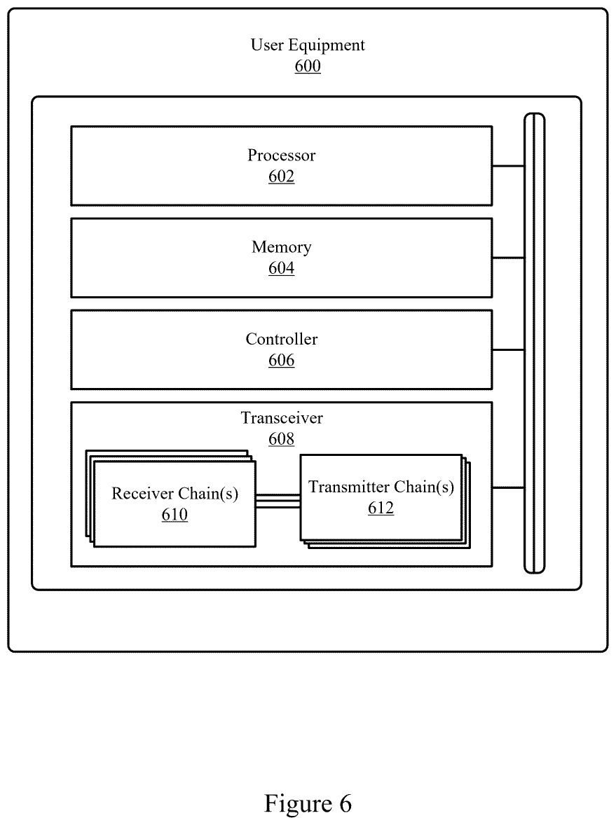

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside externally to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to generate a set of constellations associated with wireless communication, wherein the set of constellations includes a plurality of pairs of constellations, wherein each pair of constellations includes a first constellation for transmission of the wireless communication and a second constellation for reception of the wireless communication; and transmit information of at least a subset of the set of constellations.

Additionally, the processor 700 may be configured to or operable to support any one or combination of where the first constellation is configured for bit mapping, and wherein the second constellation is configured for bit demapping; the first constellation and the second constellation have different constellation arrangements; the set of constellations is generated based at least in part on an objective function; the objective function is based at least in part on a BICM function; the objective function is based at least in part on a first constellation for a transmitter constellation and a second constellation for a receiver constellation, and wherein the first constellation is associated with generating a symbol for transmission, and the second constellation is associated with calculating a likelihood ratio associated with the symbol for transmission; the objective function is associated with one or more constraints, and wherein the one or more constraints are based at least in part on power normalization for the set of constellations; the set of constellations includes non-uniform constellations.

Additionally, the processor 700 may be configured to or operable to support any one or combination of where the set of constellations includes one or more of a one-dimensional non-uniform constellation, a two-dimensional non-uniform constellation, or a M-APSK constellation; the one or more constraints are based at least in part on one or more constellation types for the set of constellations; the constellation information is generated based at least in part on an objective function, and wherein the objective function is determined based at least in part on one or more of an exhaustive search, a particle swarm optimization, a genetic algorithm, or a Nelder-Mead algorithm; the first constellation is generated based at least in part on an objective function, and the second constellation is determined based at least in part on a predefined constellation for reception of wireless communication; the predefined constellation includes a QAM constellation; the constellation information is communicated to one or more of a transmitter device or a receiver device.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive information of at least a subset of a set of constellations, wherein the subset includes a pair of constellations including a first constellation for transmission of the wireless communication and a second constellation for reception of the wireless communication; and receive or transmit data based at least in part on the subset of the set of constellations.

Additionally, the processor 700 may be configured to or operable to support any one or combination of where the first constellation and the second constellation include different constellation arrangements; the first constellation and the second constellation include non-uniform constellations.

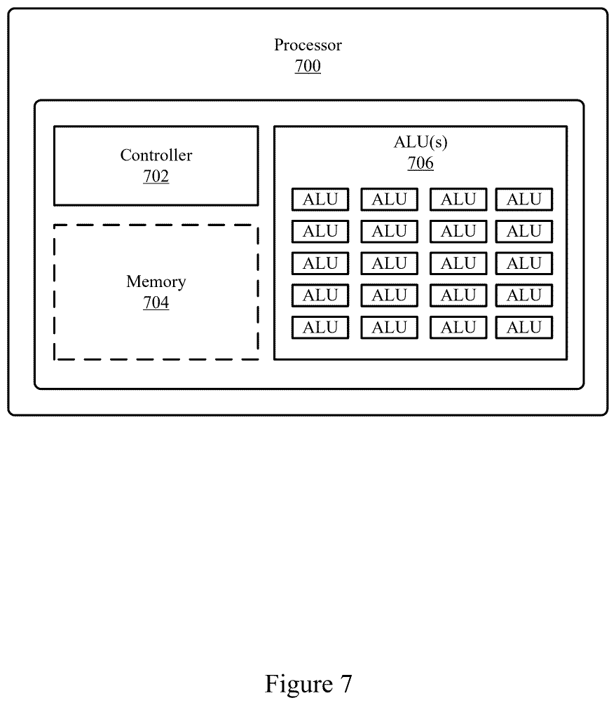

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the NE 800 may support at least one memory (e.g., the memory 804) and at least one processor (e.g., the processor 802) coupled with the at least one memory and configured to cause the NE to generate a set of constellations associated with wireless communication, wherein the set of constellations includes a plurality of pairs of constellations, wherein each pair of constellations includes a first constellation for transmission of the wireless communication and a second constellation for reception of the wireless communication; and transmit information of at least a subset of the set of constellations.

Additionally, the NE 800 may be configured to support any one or combination of where the first constellation is configured for bit mapping, and wherein the second constellation is configured for bit demapping; the first constellation and the second constellation have different constellation arrangements; the set of constellations is generated based at least in part on an objective function; the objective function is based at least in part on a BICM function; the objective function is based at least in part on a first constellation for a transmitter constellation and a second constellation for a receiver constellation, and wherein the first constellation is associated with generating a symbol for transmission, and the second constellation is associated with calculating a likelihood ratio associated with the symbol for transmission; the objective function is associated with one or more constraints, and wherein the one or more constraints are based at least in part on power normalization for the set of constellations; the set of constellations includes non-uniform constellations.

Additionally, the NE 800 may be configured to support any one or combination of where the set of constellations includes one or more of a one-dimensional non-uniform constellation, a two-dimensional non-uniform constellation, or a M-APSK constellation; the one or more constraints are based at least in part on one or more constellation types for the set of constellations; the constellation information is generated based at least in part on an objective function, and wherein the objective function is determined based at least in part on one or more of an exhaustive search, a particle swarm optimization, a genetic algorithm, or a Nelder-Mead algorithm; the first constellation is generated based at least in part on an objective function, and the second constellation is determined based at least in part on a predefined constellation for reception of wireless communication; the predefined constellation includes a QAM constellation; the constellation information is communicated to one or more of a transmitter device or a receiver device.

In some implementations, the processor 802 and the memory 804 coupled with the processor 802 may be configured to cause the NE 800 to perform one or more of the functions described herein (e.g., executing, by the processor 802, instructions stored in the memory 804). For example, the NE 800 may support at least one memory (e.g., the memory 804) and at least one processor (e.g., the processor 802) coupled with the at least one memory and configured to cause the NE to receive information of at least a subset of a set of constellations, wherein the subset includes a pair of constellations including a first constellation for transmission of the wireless communication and a second constellation for reception of the wireless communication; and receive or transmit data based at least in part on the subset of the set of constellations.

Additionally, the NE 800 may be configured to support any one or combination of where the first constellation and the second constellation include different constellation arrangements; the first constellation and the second constellation include non-uniform constellations.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

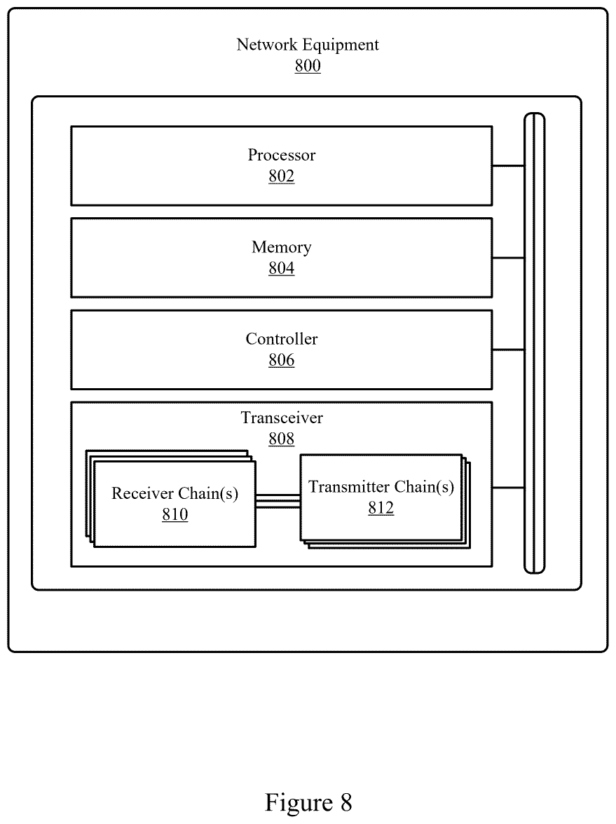

FIG. 9 illustrates a flowchart of a method 900 in accordance with aspects of the present disclosure. The operations of the method may be implemented by an apparatus (e.g., NE, UE) as described herein. In some implementations, the apparatus may execute a set of instructions to control the function elements of the apparatus to perform the described functions. It should be noted that the method described herein describes a possible implementation, and that the operations and the steps may be rearranged or otherwise modified and that other implementations are possible.

At 902, the method may include generating a set of constellations associated with wireless communication, wherein the set of constellations includes a plurality of pairs of constellations, wherein each pair of constellations includes a first constellation for transmission of the wireless communication and a second constellation for reception of the wireless communication. The operations of 902 may be performed in accordance with examples as described herein. In some implementations, aspects of the operations of 902 may be performed by a UE as described with reference to FIG. 6 and/or an NE as described with reference to FIG. 8.

At 904, the method may include transmitting information of at least a subset of the set of constellations. The operations of 904 may be performed in accordance with examples as described herein. In some implementations, aspects of the operations of 904 may be performed by a UE as described with reference to FIG. 6 and/or an NE as described with reference to FIG. 8.

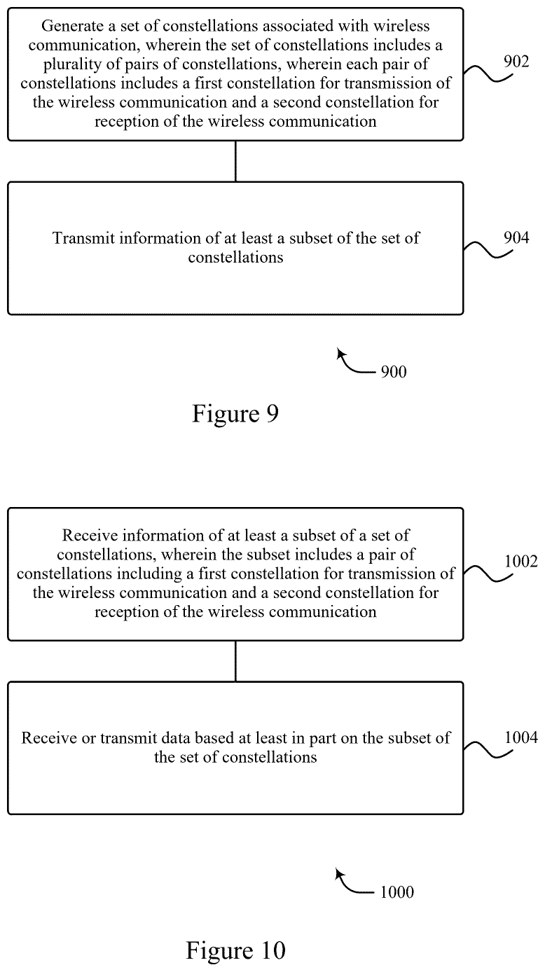

FIG. 10 illustrates a flowchart of a method 1000 in accordance with aspects of the present disclosure. The operations of the method may be implemented by an apparatus (e.g., NE, UE) as described herein. In some implementations, the apparatus may execute a set of instructions to control the function elements of the apparatus to perform the described functions. It should be noted that the method described herein describes a possible implementation, and that the operations and the steps may be rearranged or otherwise modified and that other implementations are possible.

At 1002, the method may include receiving information of at least a subset of a set of constellations, wherein the subset includes a pair of constellations comprising a first constellation for transmission of the wireless communication and a second constellation for reception of the wireless communication. The operations of 1002 may be performed in accordance with examples as described herein. In some implementations, aspects of the operations of 1002 may be performed by a UE as described with reference to FIG. 6 and/or an NE as described with reference to FIG. 8.

At 1004, the method may include receiving or transmitting data based at least in part on the subset of the set of constellations. The operations of 1004 may be performed in accordance with examples as described herein. In some implementations, aspects of the operations of 1004 may be performed by a UE as described with reference to FIG. 6 and/or an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first apparatus for wireless communication, comprising:
at least one memory; and
at least one processor coupled with the at least one memory and operable to:
generate a set of constellations associated with wireless communication, wherein the set of constellations comprises a plurality of pairs of constellations, wherein each pair of constellations comprises a first constellation for transmission of the wireless communication and a second constellation for reception of the wireless communication.

2. The first apparatus of claim 1, wherein the at least one processor is further operable to cause the first apparatus to transmit information of at least a subset of the set of constellations.

3. The first apparatus of claim 2, wherein the information of at least a subset of the set of constellations is transmitted to a second apparatus for transmission or reception of wireless communication.

4. The first apparatus of claim 1, wherein the first constellation is configured for bit mapping, and wherein the second constellation is configured for bit demapping.

5. The first apparatus of claim 1, wherein the first constellation and the second constellation have different constellation arrangements.

6. The first apparatus of claim 1, wherein the set of constellations is generated based at least in part on an objective function.

7. The first apparatus of claim 6, wherein the objective function is based at least in part on a bit-interleaved coded modulation (BICM) function.

8. The first apparatus of claim 6, wherein the objective function is based at least in part on a first constellation for a transmitter constellation and a second constellation for a receiver constellation, and wherein the first constellation is associated with generating a symbol for transmission, and the second constellation is associated with calculating a likelihood ratio associated with the symbol for transmission.

9. The first apparatus of claim 6, wherein the objective function is associated with one or more constraints, and wherein the one or more constraints are based at least in part on power normalization for the set of constellations.

10. The first apparatus of claim 9, wherein the set of constellations comprises non-uniform constellations.

11. The first apparatus of claim 10, wherein the set of constellations comprises one or more of a one-dimensional non-uniform constellation, a two-dimensional non-uniform constellation, or a M-ary amplitude phase shift keying (M-APSK) constellation.

12. The first apparatus of claim 10, wherein the one or more constraints are based at least in part on one or more constellation types for the set of constellations.

13. The first apparatus of claim 1, wherein the set of constellations is generated based at least in part on an objective function, and wherein the objective function is determined based at least in part on one or more of an exhaustive search, a particle swarm optimization, a genetic algorithm, or a Nelder-Mead algorithm.

14. The first apparatus of claim 1, wherein the first constellation is generated based at least in part on an objective function, and the second constellation is determined based at least in part on a predefined constellation for reception of wireless communication.

15. The first apparatus of claim 14, wherein the predefined constellation comprises a quadrature amplitude modulation (QAM) constellation.

16. A second apparatus for wireless communication, comprising:
at least one memory; and
at least one processor coupled with the at least one memory and operable to:
receive information of at least a subset of a set of constellations, wherein the subset comprises a pair of constellations comprising a first constellation for transmission of the wireless communication and a second constellation for reception of the wireless communication; and
receive or transmit data based at least in part on the the subset of the set of constellations.

17. The second apparatus of claim 16, wherein the first constellation and the second constellation have different constellation arrangements, and wherein the first constellation and the second constellation comprise non-uniform constellations.

18. A method, comprising:
generating a set of constellations associated with wireless communication, wherein the set of constellations comprises a plurality of pairs of constellations, wherein each pair of constellations comprises a first constellation for transmission of the wireless communication and a second constellation for reception of the wireless communication.

19. The method of claim 18, further comprising transmitting information of at least a subset of the set of constellations.

20. A method, comprising:
receiving information of at least a subset of a set of constellations, wherein the subset comprises a pair of constellations comprising a first constellation for transmission of wireless communication and a second constellation for reception of wireless communication; and
receiving or transmitting data based at least in part on the subset of the set of constellations.
